(19) United States
(12) Patent Application Publication
(10) Pub. No.: US 2007/0024426 A1
(43) Pub. Date: Feb. 1, 2007

(54) IC tag, IC tag controlling method, and IC tag system

(75) Inventors: Kazuhiro Akiyama, Kanagawa (JP); Koutarou Satou, Kanagawa (JP); Hatsuhide Igarashi, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/493,916

(22) Filed: Jul. 27, 2006

(30) Foreign Application Priority Data
Jul. 28, 2005 (JP) 2005-218242

(51) Int. Cl. H04Q 5/22

(52) U.S. Cl. 340/10.5; 340/10.41; 340/10.51; 340/572.3; 340/10.3

(57) ABSTRACT

By canceling the invalidation, there is provided an IC tag that can be reused after the IC tag's function was invalidated. An IC tag according to an embodiment operates in accordance with a standard protocol and a non-standard protocol and includes a control circuit for switching an operational mode, when receiving a KILL command during an operation based on the standard protocol, to an invalidated state based on the non-standard protocol, and when receiving a KILL cancel command during an operation based on the non-standard protocol, to a normal state based on the standard protocol.

### BACKGROUND OF THE INVENTION

1. Field of the Invention

The present invention relates to an IC tag, an IC tag controlling method, and an IC tag system. In particular, the present invention relates to an IC tag, IC tag controlling method, and an IC tag system which is operated in accordance with a predetermined communication protocol.

2. Description of Related Art

In recent years, attentions have been paid to a technique regarding RFID (Radio Frequency Identification) as a product automatic identifying technique for affixing an IC tag having product specific information written thereto, and scanning this information using a radio antenna to manage a product in real time, in merchandise logistics management at the factory and article management at a retail shop. RFID has a merit apart from a bar code technique and the others that RFID is capable to read data from several IC tag at once and rewrite data stored in the IC tag.

The above RFID IC tag (hereinafter simply referred to as “IC tag”) communicates with a reader/writer by radio to write/read data to/from a non-volatile memory in the IC tag. The IC tag communicates with the reader/writer while transmitting/receiving radio waves or data in accordance with a predetermined communication protocol.

For example, the reader/writer transmits/receives a command executed on the IC tag and the execution result to/from the IC tag, and the communication protocol standardizes a format of the command or the like. As the command, there are a read command to read data stored in the IC tag and a write command to write data to the IC tag.

On the other hand, while attentions are paid to a convenience of RFID, there is a fear that a privacy of a customer is violated.

The IC tag stores a tag ID called a unique ID for uniquely specifying an IC tag and user data that is arbitrarily written by a user. For example, it is used as information for identifying a produce attached with a tag ID and IC tag. Further, a database of an IC tag system, information about a product attached with an IC tag is managed together with the tag ID, and information about a person that purchased a product (for example, name, address, and sex) are associated (with thetag ID) in some cases. For example, the information about the person that purchased a product is used for after-the-sales service.

Therefore, if a purchaser possesses a product attached with the IC tag, the third party reads the tag ID or user data to steal information about what the purchaser bought without the purchaser knowing. Further, if a system or user data database stored in the IC tag is searched, personal data associated with the purchaser is specified and leaks. For example, there is a fear that an unauthenticated person specifies “when” and “what” “who” buys, tracks a purchaser's behavior, and identifies the purchase, and abuses the information.

As mentioned above, in the field of RFID, there is a fear that personal data leaks, so a need to protect one's privacy is arising. And also, there is an increasing demand to protect one's privacy throughout the entire society; for example, the law protecting personal information is put into force.

As a solution to a problem about how to protect one's privacy in the RFID, a KILL command (invalidating command) is known. For example, “Some Methods for Privacy in RFID Communication”, K. Fishin, S. Roy, and B. Jiang, Intel Research Seattle, Tech Memo, and IRS-TR-04-010, June, 2004 (a search was made on Jun. 15, 2005 at the Internet URL: http://www.intel-research.net/Publications/Seattle/0624200415 17_{—}243.pdf). The KILL command is standardized in a communication protocol and is widely used. This command invalidates the function of the IC tag. When receiving the KILL command, the IC tag invalidates its function, that is, stops a response to a command from the reader/writer (an operation of reading the tag ID or user data and so on). For example, when someone buys a product, a KILL command is issued to an IC tag attached to the product, thereby invalidating the function of the IC tag to prevent leakage of product or personal information and protect one's privacy.

However, if the IC tag is invalidated in response to the KILL command, the IC tag cannot be used thereafter. That is, after the purchase of the product, an advantageous service or function of the RFID cannot be provided or used to impair the convenience of the RFID. The conceivable use of the RFID after the purchase of the product is, for example, to prevent the distribution of counterfeit goods by identifying an authenticated product of a brand-name product, manage parts necessary for repairing the product and a repair history, and provides services such as sale or bonus to only a purchaser. Further, if the IC tag is permanently invalidated in response to the KILL command, the IC tag cannot be reused, resulting in the waste of resources.

As mentioned above, in the conventional techniques, if the IC tag is invalidated in response to the KILL command in order to protect one's privacy, the IC tag cannot operate anymore. Thus, there is a problem that IC tags cannot be used any longer after the execution of the KILL command.

### SUMMARY OF THE INVENTION

According to an aspect of the present invention, there is provided an IC tag, comprising: a receiving unit receiving a command of a first communication protocol and a command of a second communication protocol; and a control circuit switching a first operational mode to a second operational mode when the IC tag receives a specific command of the first communication protocol and switching the second operational mode to the first operational mode when the IC tag receives a specific command of the second communication protocol, wherein the IC tag operates based on the first communication protocol in the first operational mode and the IC tag operates based on the second communication protocol in the second operational mode.

According to the IC tag, a specific command of the first communication protocol is used to switch a first operational mode to a second operational mode, and a specific command of the second communication protocol is used to return the second operational mode to the first operational mode. Therefore, after the IC tag function is invalidated, the invalidation is cancelled, so the IC tag can be reused.

According to another aspect of the invention, there is provided a method of controlling an IC tag that receives a command of a first communication protocol and a command of a second communication protocol, comprising: switching a first operational mode to a second operational mode when the IC tag receives a specific command of the first communication protocol and switching the second operational mode to the first operational mode when the IC tag receives a specific command of the second communication protocol, wherein the IC tag operates based on the first communication protocol in the first operational mode and the IC tag operates based on the second communication protocol in the second operational mode.

According to the IC tag, a specific command of the first communication protocol is used to switch a first operational mode to a second operational mode, and a specific command of the second communication protocol is used to return the second operational mode to the first operational mode. Therefore, after the IC tag function is invalidated, the invalidation is cancelled, so the IC tag can be reused.

According to another aspect of the invention, there is provided an IC tag system, comprising: an IC tag that operates in accordance with a first communication protocol and a second communication protocol; and a reader/writer communicating with the IC tag, the IC tag comprising: a receiving unit receiving a command of a first communication protocol and a command of a second communication protocol; and a control circuit switching a first operational mode to a second operational mode when the IC tag receives a specific command of the first communication protocol and switching the second operational mode to the first operational mode when the IC tag receives a specific command of the second operational protocol, wherein the IC tag operates based on the first communication protocol in the first operational mode and the IC tag operates based on the second communication protocol in the second operational mode.

According to the IC tag, a specific command of the first communication protocol is used to switch a first operational mode to a second operational mode, and a specific command of the second communication protocol is used to return the second operational mode to the first operational mode. Therefore, after the IC tag function is invalidated, the invalidation is cancelled, so the IC tag can be reused.

According to the present invention, it is possible to provide an IC tag that can be reused after an IC tag function is invalidated, by canceling the invalidation, an IC tag controlling method, and an IC tag system.

### BRIEF DESCRIPTION OF THE DRAWINGS

The above and other objects, advantages and features of the present invention will be more apparent from the following description taken in conjunction with the accompanying drawings, in which:

FIG. 1 is a diagram of an IC tag system according to a second embodiment of the present invention;

FIGS. 2A to 2C show a command transmitted/received with an IC system of the first embodiment;

FIG. 3 is a block diagram of an IC tag of the first embodiment;

FIG. 4 is a block diagram showing the configuration of a command analyzing unit of the IC tag of the first embodiment;

FIG. 5 is a flowchart of how to switch a communication protocol of the first embodiment;

FIG. 6 is a block diagram showing the configuration of a command analyzing unit of an IC tag according to a second embodiment of the present invention; and

FIG. 7 is a block diagram showing the configuration of a command analyzing unit of an IC tag according to a third embodiment of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

First of all, an IC tag system according to a first embodiment of the present invention is described. A feature of the IC tag system of this embodiment is to change a communication protocol based on a KILL command and return the communication protocol to the original one in response to a KILL cancel command.

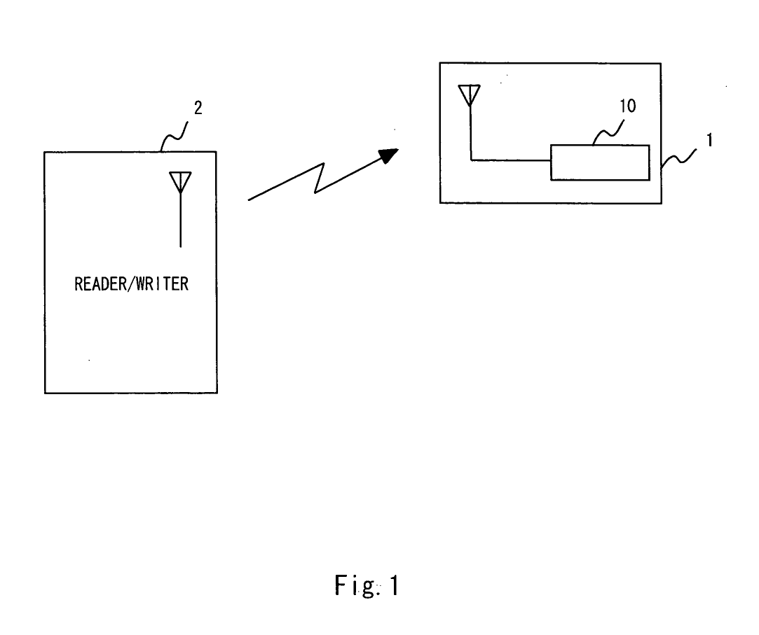

Referring now to FIG. 1, the configuration of the IC tag system of this embodiment is described. As shown in FIG. 1, the IC tag system includes a IC tag 1 and a reader/writer 2. The IC tag system is a communication system for communicating with the IC tag 1 and the reader/writer 2 by radio based on a predetermined communication protocol.

The reader/writer 2 is communicably connected with a computer (not shown), and writes/reads predetermined data to/from a storage circuit in the IC tag 1 in response to an instruction from the computer.

For example, at the time of writing/reading data to/from the IC tag 1, if the reader/writer 2 approaches the IC tag 1, the IC tag 1 receives radio waves from the reader/writer 2 to rectify the radio waves and generate a power supply voltage. The reader/writer 2 sends the command from the computer to the IC tag 1, and the IC tag 1 receives the command to write/read data to/from the storage circuit of the IC tag 1.

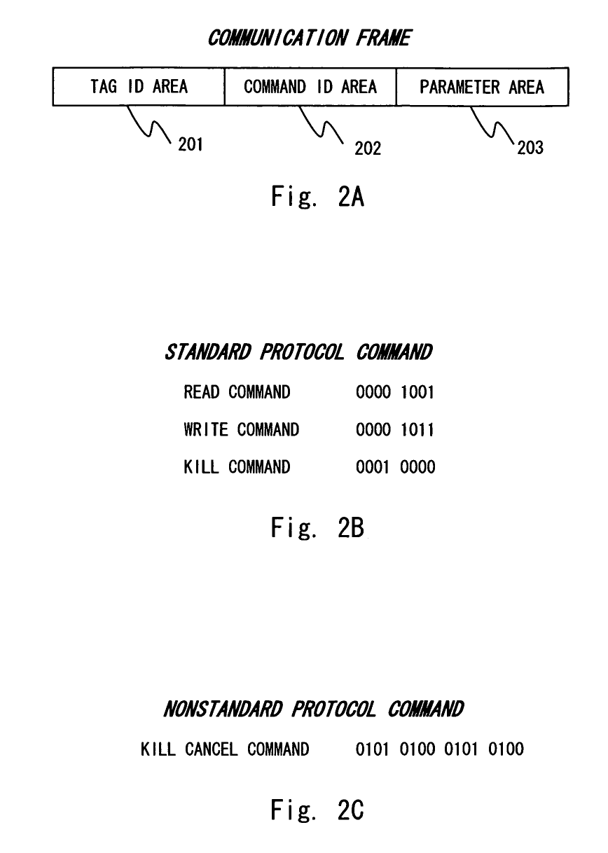

Next, referring to FIGS. 2A to 2C, a communication frame transmitted/received between the reader/writer 2 and the IC tag 1 of this embodiment and the format of the command are described.

FIG. 2A shows a communication frame transmitted from the reader/writer 2 to the IC tag 1. As shown in FIG. 2A, the communication frame includes a tag ID area 201, a command ID area 202, and a parameter area 203. The tag ID area 201 stores tag ID (IC tag identification information) of an IC tag. The command ID area 202 stores command ID (command identification information) of a command executed on the IC tag. The parameter area 203 includes parameters of a command such as a read address, a write address, and write data, in accordance with a command. Incidentally, if a tag ID of an IC tag is specified; for example, the reader/writer 2 and the IC tag 1 are provided in a one-to-one relation, a tag ID that represents a transmission destination of the communication frame may not be sent.

The communication frame is an example of a PDU (Protocol Data Unit) defined by the communication protocol, and is, for example, a format used in a layer 2 of an OSI reference model (data link layer) and higher layers.

The IC tag 1 can only interpret one communication protocol in a normal state or an invalidated state. So, in this example, the communication protocol is switched by using a KILL command (first command)/KILL cancel command (second command) to invalidate the function of the IC tag 1 or cancel the invalidation. A communication protocol used in a normal state of the IC tag 1 is defined as a standard protocol (first communication protocol). When the IC tag is under the normal state prior to the execution of the KILL command, its function is valid. A communication protocol used in an invalidated state of the IC tag 1 is defined as a non-standard protocol (second communication protocol). When the IC tag is under the non-standard protocol in a period from the execution of the KILL command to the execution of the KILL cancel command, its function is invalid. A format of the communication frame differs between the standard protocol and the non-standard protocol. If the IC tag 1 receives the communication frames of different protocols, the tag cannot analyze the frames and thus cannot operate. In particular, in this embodiment, the format of the command ID of the communication frame in the standard protocol and the non-standard protocol is changed.

FIGS. 2B and 2C show a command ID stored in the command ID area 202. In this example, as an example of changing the format of the command ID, the bit length of the command ID is changed between the standard protocol and the non-standard protocol.

As shown in FIG. 2B, the bit length of the command ID of a command used for the standard protocol (standard protocol command) is 8 bits. The standard protocol command includes plural commands for using an IC tag in a normal state, which are assigned with different command IDs. For example, this command includes a read command for reading data from the IC tag, a write command for writing data to the IC tag, and a KILL command for invalidating the IC tag function. The KILL command is also a communication protocol switching command for switching the standard protocol to the non-standard protocol.

As shown in FIG. 2C, the bit length of the command ID of a command used for the non-standard protocol command (non-standard protocol command) is 16 bits. The bit length of the command ID of the non-standard protocol command is not limited to 16 bits, and is preferably longer than that of the standard protocol command. The longer bit length than the bit length of the standard protocol command improves a security level upon canceling the invalidation of the IC tag.

The non-standard protocol command does not include a command for utilizing the function of the IC tag unlike the standard protocol, and only includes a KILL cancel command for canceling the invalidation the IC tag function (recovering the IC from the invalidation), that is, validating the IC tag function. The KILL cancel command is also a communication protocol switching command for switching the non-standard protocol to the standard protocol.

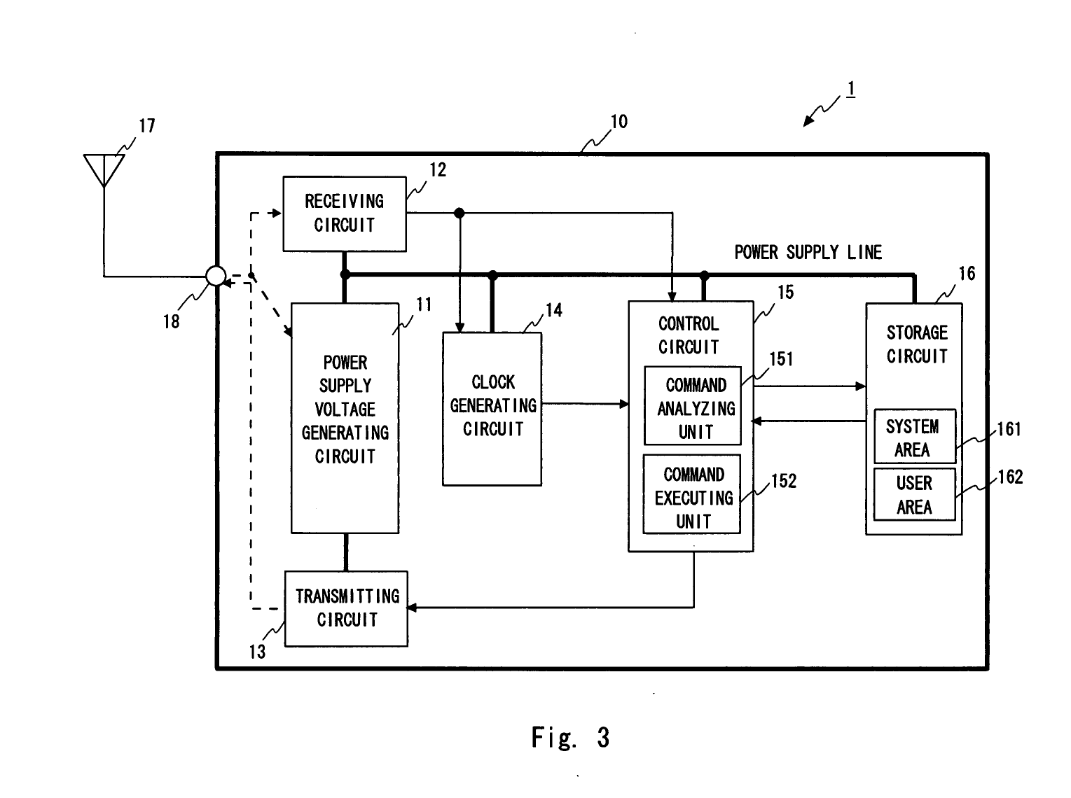

Referring next to FIG. 3, the configuration of the IC tag of this embodiment is described. As shown in FIG. 3, the IC tag 1 includes a semiconductor device 10, and an antenna 17, and the semiconductor device 10 and the antenna 17 are connected via an antenna terminal 18. The semiconductor device 10 further includes a power supply voltage generating circuit 11, a receiving circuit 12, a transmitting circuit 13, a clock generating circuit 14, a control circuit 15, and a storage circuit 16.

The antenna 17 transmits/receives radio waves to/from the reader/writer 2, and has characteristics corresponding to a frequency of the radio waves transmitted from the reader/writer 2. The power supply voltage generating circuit 11 rectifies the radio waves received at the antenna 17 to generate a power supply voltage based on amplitude of the radio waves. The power supply voltage is supplied to the receiving circuit 12, the transmitting circuit 13, the clock generating circuit 14, the control circuit 15, and the storage circuit 16 and so on.

The receiving circuit 12 demodulates the radio waves received at the antenna 17 and converts the waves into a demodulation signal. The demodulation signal is output to the clock generating circuit 14 or the control circuit 15. The transmitting circuit 13 modulates a data signal including data generated and sent by the control circuit 15 to convert the signal into a modulation signal. The modulation signal is sent to the reader/writer 2 through the antenna 17 in the form of radio waves.

The clock generating circuit 14 extracts a frame pulse of a predetermined cycle from the demodulation signal generated by the receiving circuit 12 to generate a clock signal corresponding to the frame pulse. The clock signal is output to the control circuit 15.

The control circuit 15 demodulates the demodulation signal generated by the receiving circuit 12 to extract or analyze a command, and reads/writes data from/to the storage circuit 16 based on the command. The control circuit 15 includes a command analyzing unit 151 for analyzing the received command, and a command executing unit 152 for executing the analyzed command. The control circuit 15 switches the operational state to the invalidated state (second operational mode) where the tag operates based on the non-standard protocol (second communication protocol) when receiving the KILL command during the normal state (first operational mode) in which the tag operates based on the standard protocol (first communication protocol) and switches the operational state to the normal state when receiving the KILL command during the invalidated state, by using the command analyzing unit 151 and the command executing unit 152.

The command analyzing unit 151 determines whether the command ID of the received communication frame is a standard protocol command or a non-standard protocol command. The command analyzing unit 151 analyzes the received command based on a KILL flag (KILL flag 323 as described below) that represents a normal state/invalidated state (operational mode). The command executing unit 152 executes the command analyzed by the command analyzing unit 151. Further, the command executing unit 152 is a flag information setting unit for setting the KILL flag when the command analyzed by the command analyzing unit 151 is the KILL command/KILL cancel command.

For example, if the command analyzed by the command analyzing unit 151 is a write command, the command executing unit 152 turns on/off a write control signal for controlling an operation of writing data to the storage circuit 16, or turns on/off a charge pump control signal for controlling an operation of a charge pump of the storage circuit 16. Further, if the command analyzed by the command analyzing unit 151 is a read command, the command executing unit 152 turns on/off a read control signal to read data from the storage circuit 16, generate a data signal to be sent to the reader/writer 2 based on the read data, and output the data signal to the transmitting circuit 13. If the command analyzed by the command analyzing unit 151 is a KILL command/KILL cancel command, the command executing unit 152 sets the KILL flag to switch the communication protocol of the command analyzed by the command analyzing unit 151.

The storage circuit 16 is a memory for storing data received from the reader/writer 2, for example, a non-volatile memory. The storage circuit 16 stores/outputs data under the control of the control circuit 15. The storage circuit 16 may be an EEPROM (Electrically Erasable Programmable ROM), a flash memory, an FeRAM (Ferroelectric RAM, an MRAM (Magnetic RAM), or an OUM (Ovonic Unified Memory) as the non-volatile memory. Further, the storage circuit 16 includes a step-up circuit such as the charge pump, and the step-up circuit boosts the power supply voltage up to a level necessary for writing data at the time of writing data.

The storage circuit 16 includes a system area 161 that can be rewritten by a user and a user area 162 that cannot be rewritten by the user. The system area 161 stores the tag ID or the KILL flag as described below, and the user area 162 stores arbitrary user data.

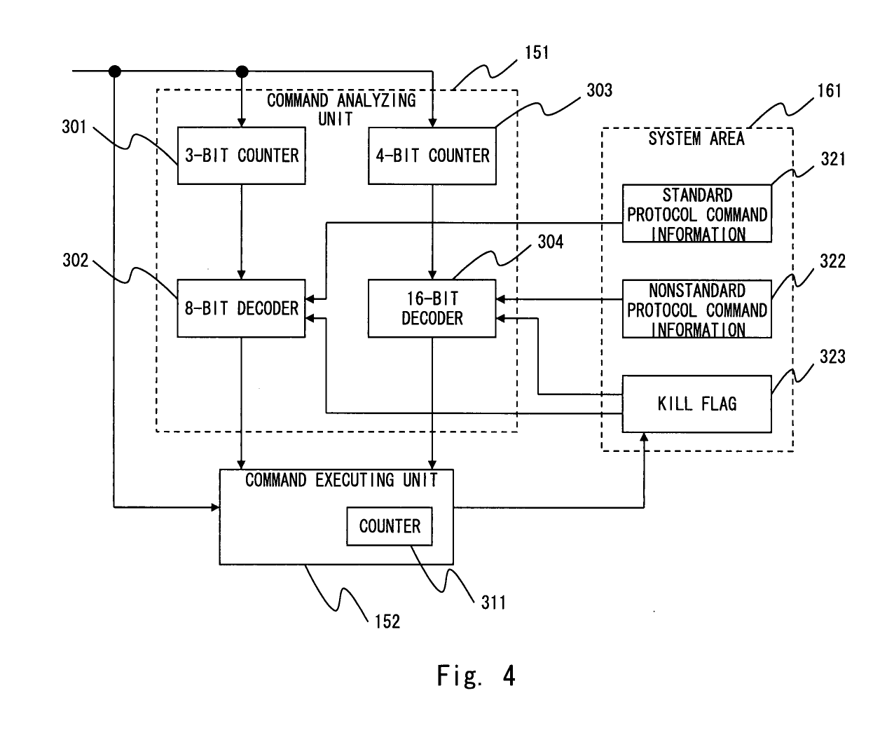

Referring next to FIG. 4, the configuration of the command analyzing unit 151, the command executing unit 152, and the system area 161 of this embodiment is described. As shown in FIG. 4, the command analyzing unit 151 includes a 3-bit counter 301, an 8-bit decoder 302, a 4-bit counter 303, and a 16-bit decoder 304.

The system area 161 stores standard protocol command information 321, non-standard protocol command information 322, and the KILL flag 323. The standard protocol command information 321 is the standard protocol command of FIG. 2B, that is, the command ID of the KILL command or the like. The non-standard protocol command information 322 is the non-standard protocol command of FIG. 2C, that is, the command ID of the KILL cancel command. The KILL flag 323 represents the invalidated state/normal state of the IC tag, that is, represents that the communication protocol is the standard protocol/non-standard protocol. For example, if the KILL flag 323 is set to “1”, the flag represents the invalidated state of the tag. If the KILL flag 323 is reset to “0”, the flag represents the normal state of the tag.

For example, if the communication frame is received from the reader/writer 2, the command ID area 202 of the communication frame is input to the command analyzing unit 151, and the tag ID area 201 and the parameter area 203 of the communication frame are input to the command executing unit 152. The boundary between the command ID area 202 and the parameter area 203 is defined based on the KILL flag, and a parameter is retrieved from a bit position in accordance with the standard protocol/non-standard protocol and input to the command executing unit 152.

If the command analyzed by the command analyzing unit 151 is the KILL command, the command executing unit 152 sets the KILL flag 323 to switch the communication protocol to the non-standard protocol. If the analyzed command is the KILL cancel command, the unit resets the KILL flag 323 to switch the communication protocol to the standard protocol. If the KILL flag 323 is set to “0”, the command analyzing unit 151 receives only the standard protocol command, that is, analyzes only the 8-bit command ID. In contrast, if the KILL flag 323 is set to “1”, the unit receives only the non-standard protocol command, that is, analyzes only the 16-bit command ID.

The 3-bit counter 301 is a command ID input unit for inputting a command ID of the standard protocol command. The 3-bit counter 301 receives the command ID of the communication frame, and counts the input bit number. When the counter counts up to 8 bits, the input 8-bit command ID is output.

The 8-bit decoder 302 is a command decoder for decoding the command ID of the standard protocol command. The 8-bit decoder 302 receives the 8-bit command ID, references the standard protocol command information 321, and determines which command of the standard protocol commands the command ID is. For example, if the command ID is “00010000” in FIG. 2B, the analyzing unit determines that the command is the KILL command, and outputs a signal indicating the KILL command to the command executing unit 152.

Further, the 8-bit decoder 302 references the KILL flag 323 to execute a decoding operation based on a value of the KILL flag 323. For example, if the KILL flag 323 is set to “0”, the decoding operation is executed. In contrast, if the KILL flag 323 is set to “1”, the decoding operation is not executed.

The 4-bit counter 303 is a command ID input unit for inputting the command ID of the non-standard protocol command. The 4-bit counter 303 receives the command ID of the communication frame and counts the input bit number. When the counter counts up to 16 bits, and outputs the input 16-bit command ID.

The 16-bit decoder 304 is a command decoder that decodes the command ID of the non-standard protocol command. The 16-bit decoder 304 receives the 16-bit command ID, and references the non-standard protocol command information 322 to determine whether or not the command ID represents the KILL cancel command as the non-standard protocol command. For example, if the command ID is “0101010001010100” in FIG. 2C, the unit determines that the command is the KILL cancel command, and a signal indicating the KILL cancel command is output to the command executing unit 152.

Further, the 16-bit decoder 304 references the KILL flag 323, and executes the decoding operation based on the value of the KILL flag 323. For example, if the KILL flag 323 is set to “1”, the decoding operation is executed. In contrast, if the KILL flag 323 is set to “0”, the decoding operation is not performed.

Incidentally, a shift register may be provided in place of the 3-bit counter 301 and the 4-bit counter 303. In this case, the shift register receives the 8- or 6-bit command ID, and inputs the command ID based on the KILL flag to the 8-bit decoder 302 or the 16-bit decoder 304.

The command executing unit 152 includes a counter 311 for counting the number of received KILL cancel commands. When the counter 311 counts the received KILL cancel commands up to the predetermined number, the KILL flag 323 is reset to improve a security level upon canceling the invalidation.

Incidentally, if the bit length of the KILL cancel command is long, and the security is secured, the KILL cancel command may not be counted, and the KILL flag 323 may be reset upon the reception of one KILL cancel command. Further, it is possible to count KILL commands by use of the counter 311 as well as the KILL cancel command. Then, when the KILL commands are received up to the predetermined number, the KILL flag 323 may be set.

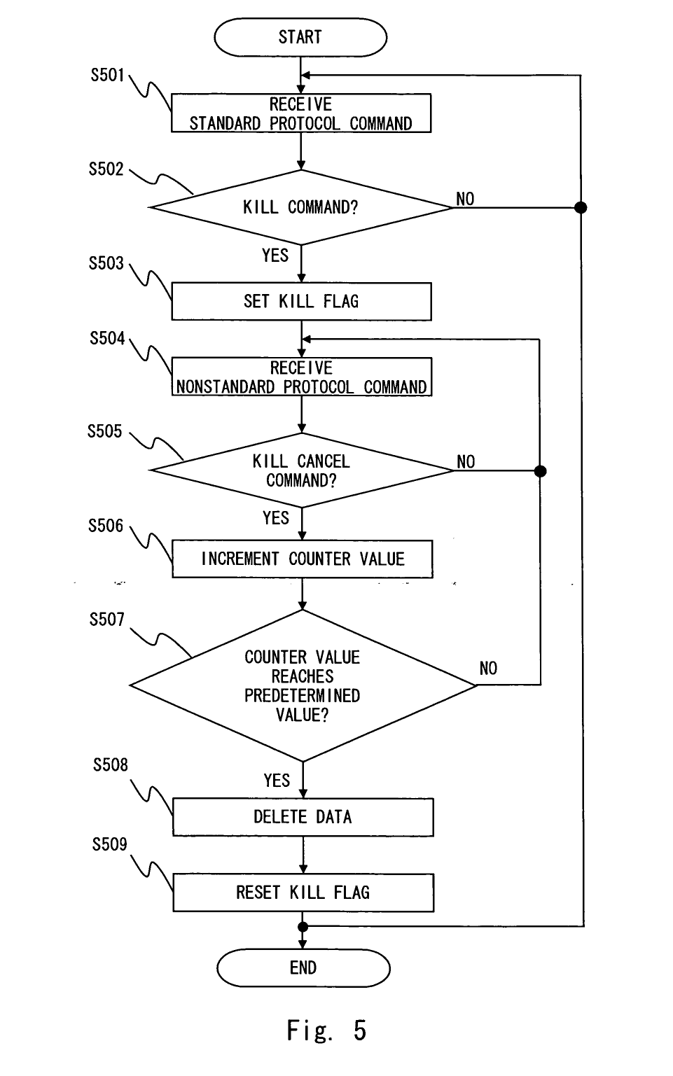

Referring next to a flowchart of FIG. 5, a process of switching the communication protocol of the IC tag of this embodiment is described. This process is executed when the IC tag receives the KILL command or KILL cancel command to switch the state of the IC tag, that is, the communication protocol. Incidentally, the initial state before this process is such that the KILL flag 323 is set to “0”, and the IC tag 1 is in the normal state, that is, the communication protocol is a standard protocol.

First, the command analyzing unit 151 receives the standard protocol command (S501). That is, when the IC tag 1 receives the communication frame, the tag ID of the communication frame is input to the command executing unit 152, and the command ID of the communication frame is input to the 3-bit counter 301 to supply the counted 8-bit command ID to the 8-bit decoder 302.

Next, the command analyzing unit 151 determines whether or not the received command is the KILL command (S502). That is, the 8-bit decoder 302 executes decoding since the KILL flag 323 is set to “0”, and compares the received command ID on S501 with the command ID of the standard protocol command information 321, and search for a command having a command ID that matches the above command ID.

If it is determined that the received command is the KILL command in S502, a KILL processing (invalidating) is executed. As the KILL processing, the command executing unit 152 sets the KILL flag 323 (S503). That is, if the received command ID matches the command ID of the KILL command, the 8-bit decoder 302 notifies the command executing unit 152 that the KILL command is received. As a result, the command executing unit 152 sets the KILL flag 323 to “1”. Hence, the IC tag 1 is brought into the invalidated state, and the communication protocol is switched to the non-standard protocol. That is, the 8-bit decoder 302 stops the operation, and the 16-bit decoder 304 starts operating.

Further, if it is determined that the received command is not the KILL command in S502, the command executing unit 152 writes/reads data to/from the storage circuit in accordance with the command. Further, in S501, the unit waits until the command is received.

Next, the command analyzing unit 151 receives the non-standard protocol command (S504). That is, if the IC tag 1 receives the communication frame, the tag ID of the communication frame is input to the command executing unit 152, and the command ID of the communication frame is input to the 4-bit counter 303. Then, the counted 16-bit command ID is input to the 16-bit decoder 304.

Next, the command analyzing unit 151 determines whether or not the received command is the KILL cancel command (S505). That is, the 16-bit decoder 304 executes decoding since the KILL flag 323 is set to “1”, and compares the received command ID on S504 with the command ID of the non-standard protocol command information 322, that is, the command ID of the KILL cancel command, and determine whether or not the IDs are matched.

If it is determined that the received command is the KILL cancel command in S505, the counter 311 is incremented (S506). That is, if the received command ID matches the command ID of the KILL cancel command, the 16-bit decoder 304 notifies the command executing unit 152 that the KILL cancel command is received. As a result, the command executing unit 152 increments the counter 311.

If it is determined that the received command is not the KILL cancel command in S505, the command executing unit 152 does not execute the received command and waits until the non-standard command is received in S504.

Next, the command executing unit 152 determines whether or not the count value of the counter 311 reaches a predetermined value (S507). If the counter value of the counter 311 reaches the predetermined value, the KILL cancel (invalidation cancel) processing (S508, S509) is executed; otherwise, the unit waits until the non-standard command (KILL cancel command) is received in S504.

As the KILL cancel processing, first, the command executing unit 152 deletes the data (S508). That is, the command executing unit 152 deletes data of the system area 161 or the user area 162 in accordance with the use of the IC tag after the cancellation of the KILL command. For example, the user data of the user area 162 is deleted, or the tag ID of the system area 161 is deleted. Further, after the cancellation of the KILL command, if the IC tag is used while keeping the data before executing the KILL command, the data is not deleted.

Next, the command executing unit 152 resets the KILL flag 323 (S509). That is, the command executing unit 152 resets the KILL flag 323 to “0” to complete the KILL cancel processing. Thus, the IC tag 1 returns to the normal state, and the communication protocol is switched to the standard protocol. That is, the 16-bit decoder 304 stops operating, and the 8-bit decoder 302 starts operating. Then, in S501, the reception of the standard protocol command is allowed.

As mentioned above, in this embodiment, if the KILL command is received during the communication based on the standard protocol, the communication protocol is switched to the non-standard protocol, thereby invalidating the IC tag function. Furthermore, if the KILL command is received during the communication based on the non-standard protocol, the communication protocol is switched to the standard protocol, thereby canceling the invalidation of the IC tag function. Accordingly, even after the IC tag function is invalidated in response to the KILL command, the invalidation of the IC tag function is cancelled based on the KILL cancel command, and the IC tag can be reused.

That is, due to the KILL command, it is possible to prevent leakage of personal information from the IC tag and protect a privacy. Due to the KILL cancel command, it is possible to reuse the IC tag while protecting a privacy and ensuring a security. In particular, upon receiving the KILL cancel command, the user data or tag ID written to the storage circuit is deleted, making it possible to securely protect a privacy. Further, if the KILL cancel command is received several times, the invalidation is cancelled, thereby making is possible to ensure the security of the KILL cancel command and to more safely reuse the IC tag.

For example, in the case where a product attached with an IC tag is offered at a retail shop or the like, the IC tag is invalidated based on the KILL command when someone buys the product, thereby preventing the leakage of personal information about the purchaser. Then, in a shop that provides the after-the-sales services, the invalidation of the IC tag function is cancelled as needed based on the KILL cancel command, so the IC tag can be effectively reused.

Further, if a retail shop has an expired product, an IC tag is removed from the product to invalidate the IC tag function based on the KILL command. Then, if it is required to attach the IC tag to another product or the like, the invalidation of the IC tag is cancelled based on the KILL cancel command, and new information is written onto the tag. In this way, the IC tag can be reused.

### Second Embodiment

Next, an IC tag according to a second embodiment of the present invention is described. A feature of the IC tag of this embodiment is that decoders for analyzing the KILL command, and counters and decoders for analyzing the KILL cancel command are shared. This embodiment describes an example where the counter and decoders are shared as the configuration of the command analyzing unit, but only the counter or decoder is shared. Incidentally, the configuration of the IC tag system or the communication frame of the IC tag of this embodiment is the same as the first embodiment, so its description is omitted here.

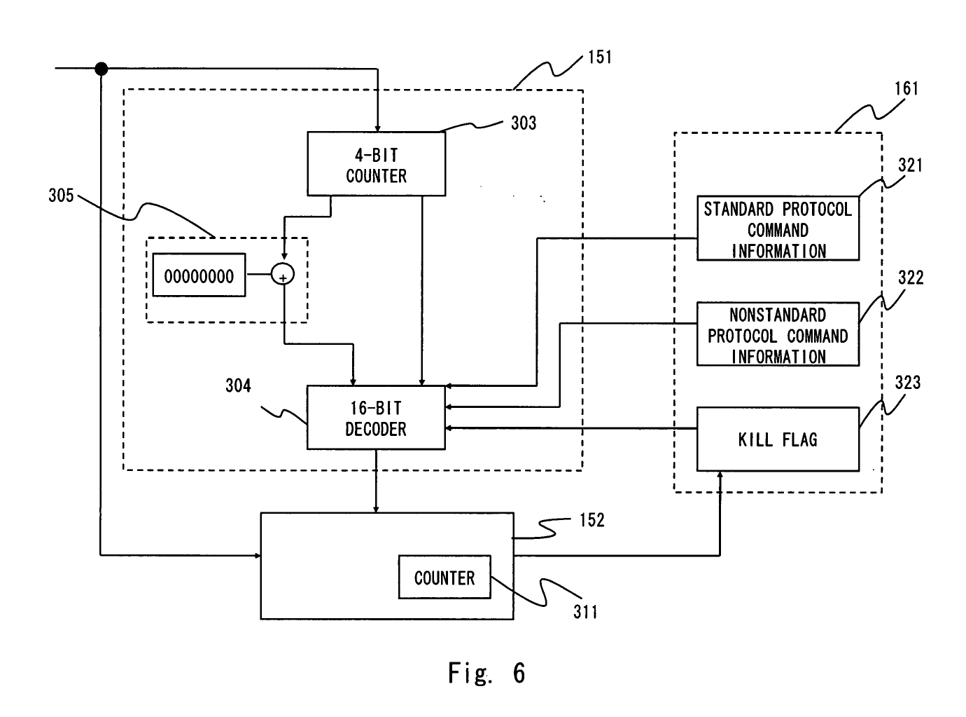

FIG. 6 shows the configuration of a command analyzing unit 151, a command executing unit 152, and a system area 161 of this embodiment. In this embodiment, as compared with the first embodiment of FIG. 4, neither the 3-bit counter 301 nor the 8-bit decoder 302 is provided, and a bit addition unit 305 is provided instead. Incidentally, the same components as those of FIG. 4 are denoted by like reference numerals, and their description is omitted here if not necessary.

The 4-bit counter 303 counts the command IDs of the standard protocol command or of the non-standard protocol command based on the KILL flag 323. In the case of counting the command IDs of the standard protocol command, when the counter counts the input bit number up to 8 bits, the 8-bit command ID is output to the bit addition unit 305. In the case of counting the command IDs of the non-standard protocol command, when the counter counts the input bit number up to 16 bits, the 16-bit command ID is output to the 16-bit decoder 304.

The bit addition unit 305 receives the 8-bit command ID from the 4-bit counter 303 and adds 8-bit code “0” to the head of the 8-bit command ID to convert the ID into the 16-bit command ID, and then outputs the 16-bit command ID to the 16-bit decoder 304.

In order to decode with the 16-bit decoder 304 after the 8-bit standard protocol command is converted into 16-bit one, the standard protocol command information 321 stores the 16-bit command ID obtained by adding the 8-bit code “0” to the 8-bit command ID. For example, “00010000” of the KILL command of FIG. 2B is stored as “0000000000010000”.

The 16-bit decoder 304 decodes the standard protocol command or the non-standard protocol command based on the KILL flag 323. For example, if the KILL flag 323 is set to “0”, the standard protocol command information 321 is referenced. If the KILL flag 323 is set to “1”, the non-standard protocol command information 322 is referenced. Then, the decoder specifies and decodes a command of the 16-bit command ID from the bit addition unit 305 or the 4-bit counter 303.

As mentioned above, in this embodiment, one counter and one decoder are used to realize the analysis of commands of two communication protocols. If two counters and two decoders are provided as in the first embodiment, there is a problem of a large circuit scale. In this embodiment, however, the 3-bit counter and the 8-bit decoder can be omitted, so the circuit scale can be reduced.

### Third Embodiment

Next, an IC tag according to a third embodiment of the present invention is described. The IC tag of this embodiment has a feature that encoded data is received from the reader/writer in addition to the KILL cancel command to decode the encoded data. Incidentally, the configuration of the IC tag system based on the IC tag of this embodiment is the same as the first embodiment, so its description is omitted here.

A communication frame transmitted/received in this embodiment is similar to that of the first embodiment as shown in FIGS. 2A to 2C, but in the case of the KILL cancel command, the parameter area 203 stores encoded data. The encoded data is data prepared by encoding plaintext data with a predetermined encryption key by use of the reader/writer 2.

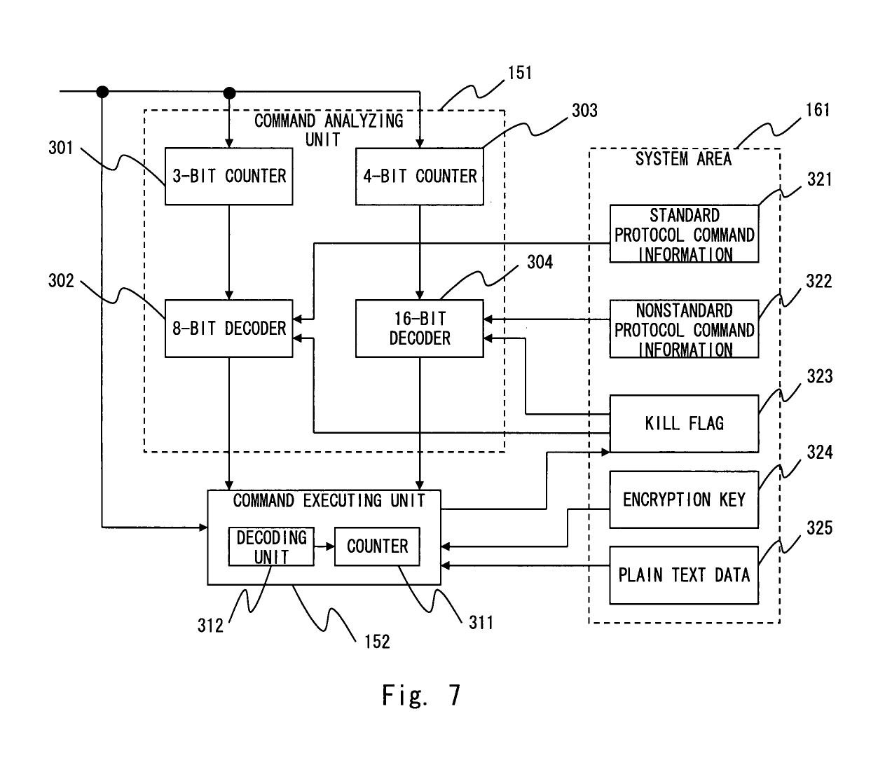

FIG. 7 shows the configuration of the command analyzing unit 151, the command executing unit 152, and the system area 161 of this embodiment. The tag of this embodiment includes, in addition to the components of the first embodiment as shown in FIG. 4, a decoding unit 312 in the command executing unit 152, and an encryption key 324 and plaintext data 325 are stored in the system area 161. Incidentally, in FIG. 7, the same components as those of FIG. 4 are denoted by like reference numerals, and their description is omitted here if not necessary.

The system area 161 stores the same encryption key 324 as that used for encoding the data with the reader/writer 2, and the same plaintext data 325 as that encoded by the reader/writer 2.

When the 16-bit decoder 304 decodes the KILL cancel command, the decoding unit 312 retrieves encoded data of the parameter area 203 in the communication frame and decodes the data with the encryption key 324. Thereafter, the decoded data is compared with the plaintext data 325. If matched, the commands are counted with the counter 311, and only after the overflow of the counter 311, the KILL flag 323 is reset.

As described above, in this embodiment, only when the encoded data can be decoded during the execution of the KILL cancel command, the KILL flag is reset to switch the communication protocol. Thus, the security level at the time of canceling the KILL command can be increased.

Incidentally, the decoding unit 312 may be provided to the IC tag of the second embodiment to execute decoding. Further, the encoded data may be added to not only the KILL cancel command but also the KILL command, and the IC tag function may be invalidated only when the encoded data can be decoded.

### Other Embodiments

In the above embodiments, the standard protocol and the non-standard protocol are different in bit length of the command, but the communication protocol may be changed using another method. For example, the bit of the communication frame may be inverted. In this case, at the time of invalidating the function in response to the KILL command, the bit is inverted before being supplied to the decoder to prevent decoding of the standard protocol command and to decode only the KILL cancel command.

Further, a coding system for coding data into communication frame may be changed. For example, in the standard protocol, “HL (high level+low level)” of the transmitted/received modulation signal is defined as “0” of 1 bit, and “HH (high level+high level)” is defined as “1” of 1 bit, in the non-standard protocol, an opposite combination, that is, “HH (high level+high level)” of the transmitted/received modulation signal is defined as “0” of 1 bit, and “HL (high level+low level)” is defined as “1” of 1 bit.

Alternatively, different modulating systems may be used for the standard protocol and the non-standard protocol. For example, if the communication is performed with the ASK modulation in the standard protocol, the communication may be performed with the PSK modulation in the non-standard protocol.

The above embodiments describe a passive type IC tag including no power supply. However, the present invention is not limited thereto, and an active type IC tag including a power supply may be used. In the active type IC tag, the KILL command is issued to invalidate the IC tag function in the case where the IC tag is not used for a while, thereby preventing the wasteful power consumption. Then, when the IC tag is used again, the KILL cancel command is used to cancel the invalidation cancel to allow the IC tag to perform normal operation.

In the above embodiments, the reader/writer communicates with the IC tag by radio, but the reader/writer and the IC tag are connected during the communication instead.

It is apparent that the present invention is not limited to the above embodiment that may be modified and changed without departing from the scope and spirit of the invention.

What is claimed is:

1. An IC tag, comprising:
a receiving unit receiving a command of a first communication protocol and a command of a second communication protocol; and
a control circuit switching a first operational mode to a second operational mode when the IC tag receives a specific command of the first communication protocol and switching the second operational mode to the first operational mode when the IC tag receives a specific command of the second communication protocol,
wherein the IC tag operates based on the first communication protocol in the first operational mode and the IC tag operates based on the second communication protocol in the second operational mode.

2. The IC tag according to claim 1, further comprising a storage circuit that stores predetermined data,
wherein the control circuit switches the second operational mode to the first operational mode, when receiving a specific command during the second operational mode and deletes the predetermined data stored in the storage circuit.

3. The IC tag according to claim 2, wherein the predetermined data to be deleted includes a tag ID written to a system area in the storage circuit.

4. The IC tag according to claim 2, wherein the predetermined data to be deleted includes user data written to a user area in the storage circuit.

5. The IC tag according to claim 1, wherein the first communication protocol and the second communication protocol are different in a communication frame to be transmitted/received.

6. The IC tag according to claim 5, wherein the specific command in the first communication protocol and the specific command in the second communication protocol are different in bit length of command identification information in the communication frame.

7. The IC tag according to claim 5, wherein the bit of the communication frame to be transmitted/received is inverted between the first communication protocol and the second communication protocol.

8. The IC tag according to claim 5, wherein the first communication protocol and the second communication protocol are different in a method of coding the bit of the communication frame to be transmitted/received.

9. The IC tag according to claim 6, further comprising a flag storing unit storing flag information that represents the first operational mode or the second operational mode,
wherein the control circuit includes:
a command analyzing unit analyzing a received command based on the flag information; and
a flag information setting unit setting the flag information based on the result of analyzing a specific command by the command analyzing unit.

10. The IC tag according to claim 9, wherein the command analyzing unit includes:
a first decoder decoding a command of a first bit length based on the flag information; and
a second decoder decoding a command of a second bit length based on the flag information, and
the flag information setting unit sets the flag information based on the decoding result of the first or second decoder.

11. The IC tag according to claim 9, wherein the command analyzing unit includes:
a bit addition unit adding a bit to a command of a first bit length up to a second bit length; and
a decoder decoding the first command added with the bit or a command of the second bit length based on the flag information.

12. The IC tag according to claim 1, wherein the control circuit switches the operational mode if receiving the specific commands of the first communication protocol or the second communication protocol two or more times.

13. The IC tag according to claim 1, wherein the control circuit receives encoded data in addition to the specific command of the first communication protocol or the second communication protocol, and switches the operational mode only when the encoded data can be decoded.

14. A method of controlling an IC tag that receives a command of a first communication protocol and a command of a second communication protocol, comprising:
switching a first operational mode to a second operational mode when the IC tag receives a specific command of the first communication protocol and switching the second operational mode to the first operational mode when the IC tag receives a specific command of the second communication protocol,
wherein the IC tag operates based on the first communication protocol in the first operational mode and the IC tag operates based on the second communication protocol in the second operational mode.

15. The method of controlling an IC tag according to claim 14, wherein switching the second operational mode to the first operational mode, when receiving a specific command during the second operational mode and deleting the predetermined data stored in the storage circuit.

16. The method of controlling an IC tag according to claim 14, wherein the first communication protocol and the second communication protocol are different in communication frame to be transmitted/received.

17. An IC tag system, comprising:
an IC tag that operates in accordance with a first communication protocol and a second communication protocol; and
a reader/writer communicating with the IC tag,
the IC tag comprising:
a receiving unit receiving a command of a first communication protocol and a command of a second communication protocol; and
a control circuit switching a first operational mode to a second operational mode when the IC tag receives a specific command of the first communication protocol and switching the second operational mode to the first operational mode when the IC tag receives a specific command of the second operational protocol,
wherein the IC tag operates based on the first communication protocol in the first operational mode and the IC tag operates based on the second communication protocol in the second operational mode.
